(19) United States
(12) Patent Application Publication
(10) Pub. No.: US 2025/0390801 A1
(43) Pub. Date: Dec. 25, 2025

(54) SYSTEM AND A METHOD FOR MANAGING AND RESELLING EMPTY FLIGHT SEATS

(71) Applicant: Airable Aviation Inc., Richmond (CA)

(72) Inventor: Saeed Golzar, North Vancouver (CA)

(21) Appl. No.: 19/081,096

(22) Filed: Mar. 17, 2025

Related U.S. Application Data
(60) Provisional application No. 63/663,358, filed on Jun. 24, 2024.

(51) Int. Cl. G06Q 10/02; G06Q 30/0201; G06Q 50/14

(52) U.S. Cl. CPC G06Q 10/02; G06Q 30/0206; G06Q 50/14

(57) ABSTRACT

Embodiments of the present disclosure relate to a system and device for reselling empty flight seats. The system receives a first user request from a first user (seller) comprising details of one or more empty flight seats for resale. The system checks if the one or more empty flight seats are eligible for resale and updates the flight database and operator accordingly. A second user (buyer) sends an inquiry to the system to inquire about the one or more empty flight seats. The system allows the second user to buy the one or more empty flight seats and updates the status of each of the empty flight seats in real-time.

### TECHNICAL FIELD

The disclosure generally relates to management of tangible assets in the context of commercial aviation. More particularly, the disclosure relates to systems, devices, articles, and methods for providing options to passengers to resell their empty flight seats, and the coordination of aircraft operations and passengers.

### BACKGROUND

The purpose of the following description of related art is solely to provide background information pertaining to the relevant field of the disclosure. Not that this section is only to enhance the understanding of the reader with respect to the present disclosure. Therefore, unless otherwise indicated, it should not be assumed that any of the information described in this section qualifies as prior art merely by inclusion in this section.

Currently, private commercial aviation such as private jets, helicopters and charter planes offer greater adaptability for customers as compared to conventional flights. Passengers and aircraft operators have various advantages and choices to enhance the use of charter planes. Flight operators offer benefits to both passengers and themselves by allowing the passengers (sellers) to sell any unoccupied (additional) seats. This method allows the passengers to save money and simultaneously increases the occupancy rate of the charter flights, ensuring that planes do not operate with empty seats.

However, private commercial aviation poses various challenges such as real-time synchronization in databases or apps during the sale and purchase of empty flight seats, and disorganized or imposed resale costs for these seats.

### SUMMARY

This section is intended to introduce certain objectives and aspects of the present disclosure in a simplified manner. The disclosure relates to a method of reselling one or more empty flight seats in a system including at least one processor, a first user device, and a second user device in communication with the at least one processor. In some embodiments, the method includes receiving, at the at least one processor, a first user request from the first user device, wherein the first user request is received if one or more empty flight seats are available for resale, and the first user request comprises a number of empty flight seats and flight details; determining, by the at least one processor, if the one or more empty flight seats are eligible for resale; if the one or more empty flight seats are eligible for resale, updating, by the at least one processor, a flight database to show the one or more empty flight seats are eligible for resale; receiving, at the least one processor, a second user request from the second user device to inquire about the one or more empty flight seats for resale; providing, by the at least one processor, a link to the second user device to buy the one or more empty flight seats; and holding, by the at least one processor, the one or more empty seats for a time frame, wherein the time frame corresponds to a waiting time to receive a confirmation from the second user device.

In some embodiments, the method includes determining a resale cost and updating the flight database, wherein the resale cost is determined based on number of empty seats and lead time. In another embodiment, the method includes sending a credit to the first user device for selling the one or more empty flight seats; and sending the confirmation to the flight operator information characterizing the one or more empty seats are resold. In yet another embodiment, the method includes assigning the one or more empty flight seats to a second user of the second user device. The method also includes real-time synchronizing status of the one or more empty seats.

Further, the embodiments of the present disclosure encompass a system comprising a first user device, a second user device, wherein the first user device and the second user device are processor-based; at least one processor communicatively coupled to the first user device and the second user device; and at least one non-transitory processor readable storage device communicatively coupled to the at least one processor and which stores processor-executable instructions which, when executed by the at least one processor, cause the at least one processor to receive a first user request from the first user device, where the first user request is received if one or more empty flight seats are available for resale, and the first user request comprises a number of empty flight seats and flight details. The instructions further cause the at least one processor to determine if the one or more empty flight seats are eligible for resale, and if the one or more empty flight seats are eligible for resale, update a flight database to show the one or more empty flight seats are eligible for resale. The instructions further cause the at least one processor to receive a second user request from the second user device to inquire about the one or more empty flight seats for resale, provide a link to the second user device to buy the one or more empty flight seats, and hold the one or more empty seats for a time frame. The time frame corresponds to a waiting time to receive a confirmation from the second user device.

In some embodiments, the at least one processor determines a resale cost and update the flight database, wherein the resale cost is determined based on number of empty seats and lead time. In another embodiment, the at least one processor sends a credit to the first user device for selling the one or more empty flight seats and also sends the confirmation to the flight operator if the one or more empty seats are resold. In another embodiment, the at least one processor assigns the one or more empty flight seats to a second user of the second user device. The processor also real-time synchronizes status of the one or more empty flight seats.

This summary does not necessarily describe the entire scope of all aspects of the disclosure. Other aspects, features, and advantages will be apparent to those of ordinary skill in the art upon review of the following description of specific embodiments.

### BRIEF DESCRIPTION OF THE DRAWINGS

Systems, devices, and methods are described in greater detail herein with reference to the following figures in which:

FIG. 1 illustrates a general overview of the system architecture, wherein the system includes a plurality of circuits.

FIG. 2 illustrates an overview of a first user device including various components working together.

FIG. 3 illustrates an overview of a second user device including various components working together.

FIG. 4 illustrates a sequence diagram of representative interactions between one or more components including user devices, servers, database, flight operators in communication with each other.

FIG. 5 illustrates a schematic view of an aircraft including one or more empty flight seats and one or more occupied flight seats.

FIG. 6 illustrates an implementation of a method for reselling one or more empty flight seats.

FIG. 7 illustrates an implementation of a method for management of one or more empty flight seats.

The above-mentioned drawings illustrate exemplary embodiments of the disclosed methods and systems in which like reference numerals refer to the same parts throughout the different drawings. Components in the drawings are not necessarily to scale, as emphasis is placed on clearly illustrating the principles of the inventions. Some drawings may use block or schematic diagrams and thus represent without showing details such as internal circuitry of components. Also, the embodiments shown in the figures are not to be construed as limiting the inventions but only as illustrative examples of an automated method and system according to the inventions that are illustrated herein to highlight the advantages of the inventions.

### DETAILED DESCRIPTION

In the following description, associated drawings, included claims, and other parts of the document, various details are set forth to provide a detailed understanding of the disclosure and embodiments thereof. It will be apparent, however, that the disclosed embodiments may be practiced without some of these details. Several features described hereafter can each be used independently of one another or in combination of other features.

Hence, in view of the above-mentioned problems and challenges, the Applicant appreciates there is a need for an efficient system and method for managing empty flight seats and allowing users to resell and buy empty flight seats.

Embodiments of the present disclosure relate to a system and a method for reselling one or more empty flight seats in a flight. If a first user (also referred to as reseller) of the first user device identifies that they have one or more empty flight seats and wishes to resell them, the first user sends a first user request to the at least one processor. The at least one processor further analyses the first user request to check if the one or more empty flight seats are eligible for resale. Based on said analysis, if the one or more empty flight seats are eligible, a flight database is updated to record the same and the at least one processor may provide information to an output device to display the same. Subsequently, a second user (also referred to as buyer) of a second user device sends a second user request to the at least one processor to inquire about the one or more empty flight seats. The at least one processor then provides a link to the second user device to buy the one or more empty flight seats. During this time, the at least one processor holds the one or more empty flight seats for a time frame, wherein the time frame corresponds to a waiting time to receive a confirmation from the second user device. The at least one processor also updates the status of the one or more empty flight seats in real time. The system and method also assign the one or more empty flight seats from the first user to the second user if the second user buys them.

As used herein, the term “empty seats” refers to vacant seats or unoccupied seats or available seats for buying or reselling in a flight.

As used herein, the terms “flight”, “charter”, and like refer to same interpretation and may be interchangeably used throughout the specification. The flight may include a charter flight or a sightseeing flight. Similarly, “aircraft”, “aeroplane”, “private jet”, “chartered craft” and like refer to same interpretation and may be interchangeably.

As used herein, the terms “passenger” and “traveller” may refer to the same person and the terms may be interchangeably used throughout the specification. In particular, “reseller”, “user of first user device” and “first user” may refer to the same person. Similarly, “buyer”, “user of second user device” and “second user” may refer to the same person.

The term “a” or “an” when used in conjunction with the terms “comprise”, “include”, “comprising”, or “including” in the claims or the specification may mean “one”, “one or more”, “at least one”, and “a plurality” unless the content dictates otherwise. Similarly, the word “another” means “additional” or “at least a second” unless the content clearly dictates otherwise. The terms “or” and “and/or” herein when used in association with a list of items means any one or more of the items may be selected from that list.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled or coupling, can indicate that two units or devices are directly connected to one another or indirectly coupled to one another through one or more intermediate elements or devices via an electrical element, electrical signal or a mechanical element depending on the particular context. For example, as used herein, the term connected can indicate that two components are directly connected to one another.

As used herein, “input”, “send”, “transfer”, “transmit”, “receive”, “output” and their cognate terms refer to sending and/or receiving information from one unit to another unit of the system, wherein said information refer to all the data mentioned in the disclosure and may or may not be modified before or after sending and receiving the information according to the desired requirements.

The I/O device(s) as used herein includes one or more user interface input devices, such as a display, a keyboard, a mouse, a microphone, and a camera. The one or more user interface input devices may be detachable. In some embodiments, the I/O device(s) includes one or more output devices, such as displays, speakers, and lights. In some embodiments, the I/O device(s) is a single light. The one or more I/O devices may be detachable. The I/O device(s) may include one or more sensors (such as altimeters, transducers, thermometers, force sensors, strain gauge, clock) and output devices (such as actuators, displays, lights).

The processor may be any logic processing unit such as one or more microprocessors, central processing units (CPUs), digital signal processors (DSPs), graphics processing units (GPUs), application-specific integrated circuits (ASICs), programmable gate arrays (PGAs), programmed logic units (PLUS) or any such device as may be obvious to a person skilled in the art. The processor may include, but is not limited to, a processor or set of processors or any such processing unit as may be obvious to a person skilled in the art, which are configured to function in accordance with the one or more inventions described herein. The terms ‘processor’ and ‘processing unit’ may be interchangeably used throughout the specification.

The circuits as used herein refer to any components, units, hardware element, or any such unit as may be obvious to a person skilled in the art.

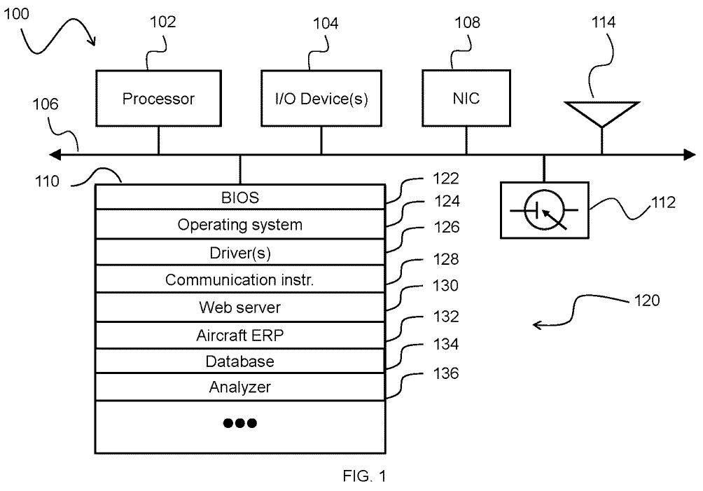

FIG. 1 illustrates a schematic view of aspects of a plurality of circuits 100 in accordance with some embodiments of the invention. The plurality of circuits 100 includes a control subsystem comprising at least one processor 102, at least one input/output (I/O) subsystem 104, and at least one bus 106 to which, or by which, the at least one processor 102 and the I/O device(s) 104 are communicatively coupled.

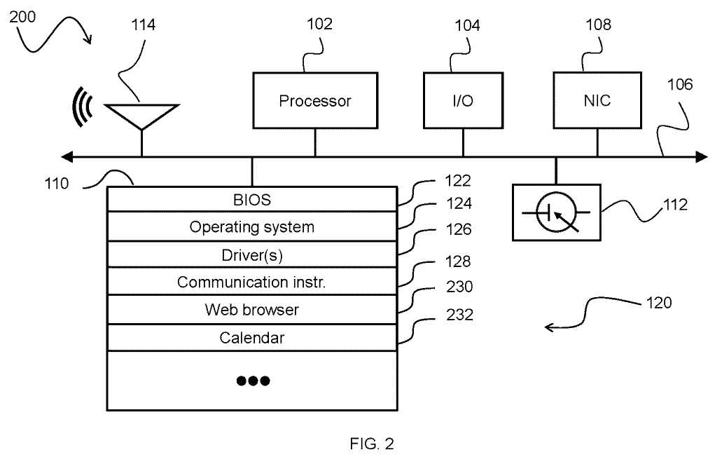

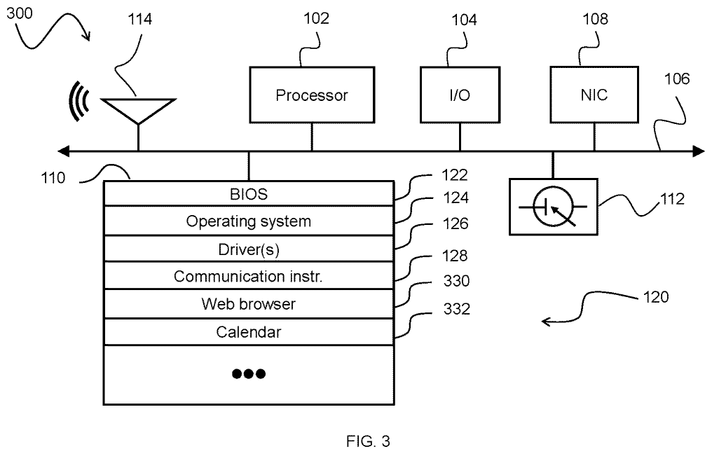

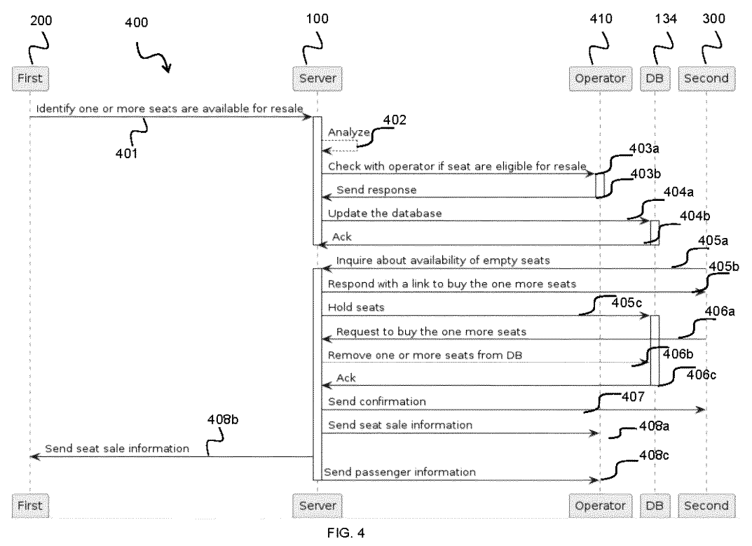

Further, the plurality of circuits 100 includes a Network Interface Card (NIC) or network interface subsystem 108 communicatively coupled to bus(es) 106, wherein the network interface subsystem 108 provides bi-directional communication to other components (e.g., a system external to plurality of circuits 100) through one or more network or non-network communication channel(s) such as the internet. In some embodiments, the network interface subsystem 108 includes a circuitry. In other embodiments, the network interface subsystem 108 uses communication protocols (e.g., FTP, HTTP, Web Services, and SOAP with XML) for bidirectional communication of information including processor-readable data, and processor-executable instructions. In some embodiments, a first user device 200 and a second user device 300 are communicatively coupled to the plurality of circuits 100 and are further described in relation to, at least, FIG. 2, FIG. 3 and FIG. 4.

Furthermore, the plurality of circuits 100 includes at least one non-transitory computer or processor-readable storage device(s) 110 coupled to the bus(es) 106. The terms ‘non-transitory computer’ and ‘processor-readable’ may be interchangeably used throughout the specification. Further, storage device(s) 110 includes at least one non-transitory storage medium. In some embodiments, Storage device(s) 110 includes two or more distinct devices, while in other embodiments, Storage device(s) 110 includes one or more volatile storage devices (e.g., Random Access Memory (RAM)), and one or more non-volatile storage devices (e.g., Read Only Memory (ROM), flash memory, magnetic hard disk (HDD), optical disk, solid state disk (SSD), and the like). In an embodiment, Storage device(s) 110 may be implemented in a variety of ways such as a read-only memory (ROM), random access memory (RAM), a hard disk drive (HDD), a network drive, flash memory, digital versatile disk (DVD) or any such forms as may be obvious to a person skilled in the art. Further, modern computer systems and techniques conflate volatile storage and non-volatile storage, for example, caching, using solid-state devices as hard drives, in-memory data processing, and the like.

Storage device(s) 110 may store on or within the included storage media processor-readable data and/or processor-executable instructions. Storage device(s) 110 include or store processor-executable instructions and/or processor-readable data 120 associated with the operation of the plurality of circuits 100, a plurality of aircraft, and the like. The terms “processor-executable instructions” and “processor-readable data” may be interchangeably used throughout the specification.

In some embodiments, the processor-executable instructions/data 120 include a Basic Input/Output System (BIOS) 122, an Operating System 124, driver(s) 126, communication instructions/data 128, a web server 130, an aircraft ERP 132, a flight database 134, an analyzer 136 and the like.

In an exemplary scenario, the operating system 124 is ANDROID®, LINUX®, WINDOWS® and the like. The driver(s) 126 include processor-executable instructions/data that allows the at least one processor 102 to control one or more components in the plurality of circuits 100. The processor-executable communication instructions/data 128 implements communications between the plurality of circuits 100 and another processor-based device through network interface subsystem 108.

The plurality of circuits 100 further includes one or more power supplies 112. In some embodiments, the power supply(ies) 112 are external power supply(ies), while in another embodiment, the power supply(ies) 112 are on-board power source(s) such as batteries, ultra-capacitors, or fuel cells, to independently power different components.

Also, the plurality of circuits 100 includes at least one antenna 114. In response to processor-executable instructions, the at least one antenna 114 emits electronic signals and receives electronic signals.

The processor-executable communication instructions/data 128, when executed, directs the plurality of circuits 100 to process input from I/O device(s) 104, antenna 114, or sensors included in a wider system, information that represents input stored on or in a storage device, such as storage device(s) 110. In some embodiments, the processor-executable communication instructions 128, when executed, direct the plurality of circuits 100 to communicate with each other.

In some embodiments, the aircraft Enterprise Resource Planning (ERP) 132, includes processor-executable input instructions or data which, when executed, directs the plurality of circuits 100 to write, update, or provide information about operational details of one or more aircraft. Aircraft ERP 132 integrates and automates various systems of record. In some embodiments, aircraft ERP 132 includes processor-executable instructions or data, which when executed, updates and/or provides information characterizing aircraft Maintenance, Repairs, and Operations (MRO) information. In another embodiment, aircraft ERP 132 includes instructions to provide real-time or near real-time data on one or more aircraft and one or more empty flight seats.

In some embodiments, the flight database 134 includes information characterizing one or more aircraft operators, a plurality of routes, a plurality of departure locations, a plurality of arrival locations, number of occupied seats, number of empty seats, number of total seats and the like. Aircraft ERP 132 may store and retrieve records from the flight database 134.

Referring to FIGS. 1-3, the first user device 200 transmits the first user request to the at least one processor 102 if the one or more empty flight seats are available for resale. The first user request comprises a number of empty flight seats and flight details. The flight details comprise a departure date, a departure location, an arrival location, flight operator information, and a seat number assigned for each of the one or more empty seats. In an embodiment, the number of passengers refer to as count of passengers travelling. The term “time” used throughout the disclosure refers to time and date. In some embodiments, the processor-executable communication instructions 128, when executed, directs the plurality of circuits 100 to provide an option to the first user device 200 to update the first user request.

In some embodiments, the web server 130, includes processor-executable instructions or data, which when executed, direct the plurality of circuits 100 to deliver content to devices (e.g., user devices) across a network (e.g., Internet). In some embodiments, the web server 130 includes a plurality of hosted files and instructions, which when executed, provides access to the hosted files. In some embodiments, the web server 130 includes an HTTP server that processes URLs (addresses) and HTTP (the protocol your browser uses to view webpages).

The analyzer 136 includes processor-executable instructions which, when executed, directs the plurality of circuits 100 to process input from the web server 130 that represents the first user request. Further, said analyzer 136, when executed, directs the plurality of circuits 100 to analyze the flight database 134 to identify if the one or more empty flight seats are eligible for resale, wherein the one more empty flight seats are eligible for resale is based on lead time, number of remaining unsold empty seats, or passenger characteristics. In an embodiment, the flight database is stored at the flight operator end (also referred to as third user device). For example, the flight operator is a non-traveller (for example, operator, aircraft crew or any such person excluding traveller as may be obvious to a person skilled in the art.

In an exemplary embodiment, the analyzer 136 accepts or rejects the first user request based on the analysis of the flight database. First user request is accepted if the one or more empty flight seats are eligible for resale whereas, in another embodiment, the first user request is rejected (i.e., not accepted) if the one or more empty flight seats are not eligible.

Further, if the one or more empty flight seats are eligible for resale, the processor-executable web server 130 updates the flight database to show that the one or more empty flight seats are eligible for resale, thereby allowing new passengers (buyers) to buy the one or more empty flight seats. Also, analyzer 136 determines a resale cost of the one or more empty flight seats and also calculates how much credit is to be provided to the first user if the one or more empty flight seat is sold.

As soon the flight database is updated, the at least one processor 102 receives the second user request from the second user device 300 to inquire about the one or more empty flight seats for buying. The processor-executable analyzer 136, when executed, analyses the second user request and provides a link to the second user for buying the one or more empty flight seats. Analyzer 136 also holds the one or more empty flight seats for a time frame when the second user is attempting to buy it or inquire more about it. In particular, the time frame corresponds to a waiting time to receive a confirmation from the second user device 300, thereby indicating that the one or more empty flight seats are sold. The status of the empty flight seats is synchronized in real time.

Further, when executed, the processor-executable analyzer 136 directs the plurality of circuits 100 to update the flight database 134 if the one or more empty flight is resold by sending the confirmation to the flight operator.

In some embodiments, the processor-executable analyzer 136 determines if there is any affect on existing passengers of the flight in an event the one or more empty flight seats are sold to the second user.

Turning to FIG. 2 which illustrates a schematic view of aspects of the first user device 200 in accordance with various embodiments of the invention. The first user device 200 includes parts in common with plurality of circuits 100. For example, both include a control subsystem comprising at least one processor 102, at least one input/output (I/O) subsystem 104, and at least one bus 106 to which the foregoing is coupled. First user device 200 includes at least one non-transitory computer or processor-readable storage device(s) 110 coupled to the bus(es) 106. Storage device(s) 110 include, but not limited to, a web browser 230 and a calendar 232.

Similarly, FIG. 3 illustrates a schematic view of aspects of second user device 300 in accordance with some embodiments of the invention. The second user device 300 includes parts in common with plurality of circuits 100. For example, both include a control subsystem comprising at least one processor 102, at least one input/output (I/O) subsystem 104, and at least one bus 106 to which the foregoing is coupled. Second user device 300 includes at least one non-transitory computer or processor-readable storage device(s) 110 coupled to the bus(es) 106. Storage device(s) 110 include, but not limited to, a web browser 330 and a calendar 332.

FIG. 4 illustrates a sequence diagram including user devices, servers, database, and a device for flight operator and interactions with each other. Shown is an exemplary sequence 400 including interactions and processes at each device, including server 100, first user device 200, second user device 300, flight operator (third user device) 410, and flight database 134. At 401, the first user device 200 identifies if the one or more empty flight seats are available for resale and accordingly notifies server 100 by sending the first user request. At 402a, the server 100 analyses the request sent at 401 by the first user device 200. At 403a, the server 100 checks with the flight operator 410 if the one or more empty flight seats are available or eligible for resale. At 403b, flight operator 410 informs server 100 if the one or more empty flight seats are available eligible by sending a response. Afterwards and in response, at 404a-404b, server 100 updates the flight database 134, and in return database 134 sends an acknowledgement.

Subsequently, at 405a, the second user device 300 sends the second user request to the processor 102 to inquire if the one or more empty flight seats available for resale. At 405b-405c, server 100 sends the link to second user device 300 allowing a user to buy the one or more empty flight seats, and simultaneously holds the seats for the time frame. At 406a-406c, second user device 300 sends a request to buy the one or more empty flight seats and once the second user device 300 buys the one or more empty flight seats, the processor 102 removes the particular empty flight seat, and the second user device 300 sends an acknowledgment. At 407, the processor 102 sends the confirmation to the second user device 300 confirming about the sold seat. At 408a-408b, the processor 102 sends seat information to the second user device 300 and the first user device 200. Also, at 408c, the processor 102 sends passenger information to the second user device 300. The database 134 and status of the empty seat are updated in real time.

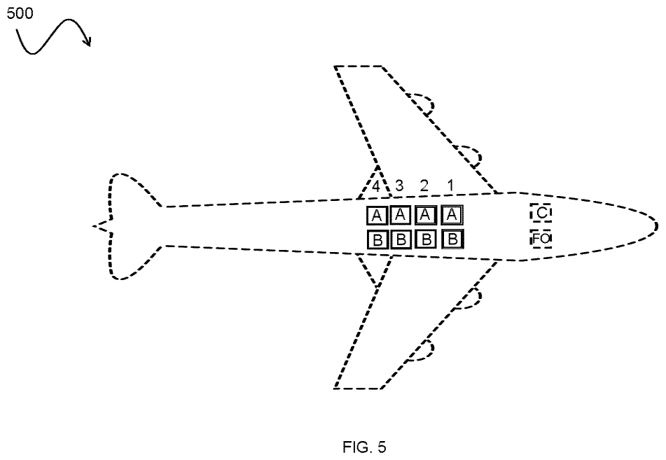

FIG. 5 illustrates a schematic view of an aircraft including one or more empty flight seats and one or more occupied flight seats. Aircraft 500 includes a plurality of flight seats among which some are empty seats, and some are occupied seats. The schematic view helps in explaining the concept behind seats in aircraft 500. The seats shown in double outline are booked seats. For example, the first user Alex had chartered a flight, and the operator intends to use aircraft 500. Alex wishes to sell the remaining empty seats. In this example, Alex and co-travellers plan to use three (3) seats 1A, 1B, and 2A. Alex needed to book the entire aircraft to get a desired point-to-point service or flight time. Now Alex wishes to sell one of the empty seats (for instance seats 2B, 3A, 3B, 4A, and 4B). Alex then sends a request to plurality of circuits 100 or flight operator 300 and requests to resell or sell his empty seats. The system will then decide if the seat is eligible to be resold and invoke methods described herein.

Still with FIG. 5 consider if Alex has sold the empty seats (e.g., 2B, 3A, 3B, 4A, and 4B) to Bhaskar such that all seats on aircraft 500 are occupied. One of Alex's co-travellers has, in this example, withdrawn, from the trip. Now Alex wishes to resell one seat, e.g., 2A. In this example, Alex and co-travellers plan to use two (2) seats 1A and 1B. Alex then sends a second request to plurality of circuits 100 or flight operator 300 and requests to resell or sell his empty seats. The system will then decide if the seat is eligible to be resold and invoke methods described herein. For example, the window to resell may have elapsed but the operator 300 may make an exception or not.

Still with FIG. 5 consider the case where Bhaskar purchased all the remaining seats and now is holding an empty seat on aircraft 500. Bhaskar wishes to resell one seat, e.g., 4B. In this example, Bhaskar sends a second request to plurality of circuits 100 or flight operator 300 and requests to resell or sell his empty seats. The system will then decide if the seat is eligible to be resold and invoke methods described herein. For example, operator 300 may not permit second order resales operator 300 may make an exception.

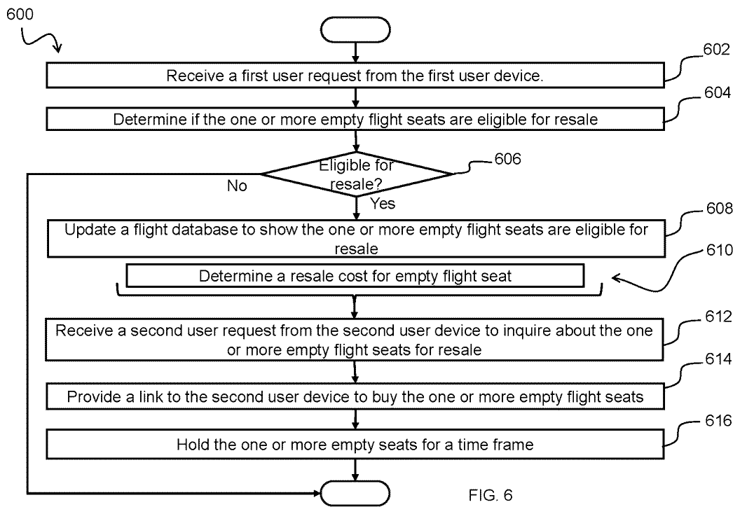

FIG. 6 illustrates an exemplary method 600 for operation or optimization of the operation of aircraft. In particular, method 600 is executable by a controller, such as circuitry or at least one hardware processor, such as at least one processor 102. Method 600 as with other methods shown herein may involve other components described herein include those described in including in relation to FIG. 1 through FIG. 4. For example, method 600 may use with the plurality of circuits 100.

Method 600 involves one or more empty seats such as those shown in FIG. 5. Method 600 is an example of a method for the operation, or improvement in the operation, of a plurality of aircraft.

A person skilled in the art will appreciate that other acts may be included, removed, and/or varied or performed in a different order to accommodate alternative implementations. The method 600 may be implemented at the bus(es) 106 through the one or more network or non-network communication channel(s) such as the internet. The method 600 may be performed by the controller (e.g., at least one processor 102) in conjunction with other components or systems as may be obvious to a person skilled in the art. In an embodiment, the controller may, by executing processor-executable instructions, represent analyzer 136, web server 130, database 134, or any such described unit/component in the disclosure. The method 600 initiates at 602.

At 602, the controller receives the first user request from the first user device 200 if the one or more empty flight seats are available for resale. The first user request comprises a number of empty flight seats and flight details. Here the request includes information characterizing one or more empty flight seats and not a count summarizing the request.

At 604, the controller determines if the one or more empty flight seats are eligible for resale. For example, through processes and communication shown in FIG. 4 at 402 and 403.

At 606, method 600 varies with the state of the data, if the one or more empty flight seats are eligible for resale. If 606—Yes, the method 600 continues at 608, else (606—No) the method 600 ends until invoked again.

At 608, the controller updates the flight database to show that the one or more empty flight seats are eligible for resale. As explained herein an operator can block resale based on order of resale, lead time, or the like.

At 610, the controller determines the resale cost of each of the one or more empty flight seats based on number of empty flight seats, lead time, flight time, repositioning costs, benchmark prices, or the like.

At 612, the controller receives the second user request from the second user device 300 to inquire about the one or more empty flight seats for resale. In some embodiments, the second user request includes a declarative request for transportation on aircraft within a timeframe. In some embodiments the second user request may include a number of passengers. For example, Bhaskar provides a declarative statement about departure, destination, and times. Bhaskar request may cover the empty seats on Alex's chartered aircraft (e.g., aircraft 500) flying from Cambell River (YBL) to Vancouver (YVR) at a time suitable to attend the final concert of Ms. Taylor Swift's “Eras” tour in December of 2024.

At 614, the controller provides information (e.g., a link) to the second user device 300 to buy the one or more empty flight seats. A user at the second user device 300 may apply the information or execute the link.

At 616, the controller holds the one or more empty flight seats for the time frame during which the second user of the second user device 300 buys the one or more empty flight seats. For example, Bhaskar is considering the purchase mindful of the finite time frame of the hold. In some implementations, the hold time is 1 minute, 2 minutes, 6 minutes, 15 minutes, 30 minutes, or 60 minutes.

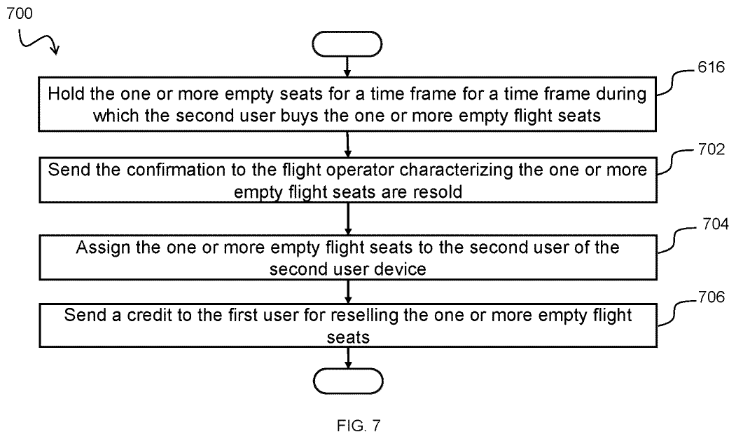

FIG. 7 illustrates another exemplary method 700 according to at least one embodiment of the invention for the operation, or improvement in the operation, of a plurality of aircraft. Method 700 is executable by a controller, such as circuitry or at least one hardware processor, such as at least one processor 102.

Method 700 starts at 616 which may be part of method 600 or another method. At 616, the controller holds the one or more empty flight seats and the second user of the second user device 300 buys the one or more empty flight seats.

At 702, the controller sends the confirmation to the flight operator 410 characterizing the one or more empty flight seats are resold. The processor also synchronizes the status of the one or more empty flight seats in real time.

At 704, the controller assigns the one or more empty flight seats to the second user of the second user device 300, for example, the passenger details are updated.

At 706, the controller sends credit to the first user of the first user device 200 for reselling the one or more empty flight seats.

For clarity, various embodiments are included in this description. Each is a numbered example.

Example 1: A method of reselling one or more empty flight seats in a system including at least one processor, a first user device, and a second user device in communication with the at least one processor, the method comprising: receiving, at the at least one processor, a first user request from the first user device, wherein the first user request is received if one or more empty flight seats are available for resale, and the first user request comprises a number of empty flight seats and flight details; determining, by the at least one processor, if the one or more empty flight seats are eligible for resale; if the one or more empty flight seats are eligible for resale, updating, by the at least one processor, a flight database to show the one or more empty flight seats are eligible for resale; receiving, at the least one processor, a second user request from the second user device to inquire about the one or more empty flight seats for resale; providing, by the at least one processor, a link to the second user device to buy the one or more empty flight seats; and holding, by the at least one processor, the one or more empty seats for a time frame, wherein the time frame corresponds to a waiting time to receive a confirmation from the second user device.

Example 2: The method of claim 1 further comprises determining a resale cost and updating the flight database, wherein the resale cost is determined based on number of empty flight seats and lead time.

Example 3: The method of claim 1 further comprising sending, by the at least one processor, a credit to the first user device for selling the one or more empty flight seats.

Example 4: The method of claim 1 further comprising, sending, by the at least one processor, the confirmation to the flight operator characterizing the one or more empty seats are resold.

Example 5: The method of claim 1 further comprising assigning the one or more empty flight seats to a second user of the second user device.

Example 6: The method of claim 1 further comprising real-time synchronizing status of the one or more empty seats.

Example 7: The method of claim 1, wherein the one more empty flight seats are eligible for resale is based on lead time, number of remaining unsold empty seats, or passenger characteristics.

Example 8: The method of claim 1, wherein: the first user device is associated with a first user and the first user is a reseller of the one or more empty flight seats; and the second user device is associated with the second user, and the second user is a buyer of the one or more empty flight seats.

Example 9: The method of claim 1, wherein the flight details comprise a departure date, a departure location, an arrival location, flight operator information, and a seat number assigned for each of the one or more empty seats.

Example 10: The method of claim 1, wherein the second user request comprises a declarative request for transportation on aircraft within a timeframe.

Example 11: The method of claim 1, wherein determining if the first user request contains one or more empty flight seats eligible for resale and checking with a flight operator corresponding to the flight details.

Example 12: A system comprising: a first user device and a second user device, wherein the first user device and the second user device are processor-based; at least one processor communicatively coupled to the first user device and the second user device; and at least one non-transitory processor-readable storage device communicatively coupled to the at least one processor and which stores processor-executable instructions which, when executed by the at least one processor, cause the at least one processor to: receive a first user request from the first user device, wherein the first user request is received if one or more empty flight seats are available for resale, and the first user request comprises a number of empty flight seats and flight details; determine if the one or more empty flight seats are eligible for resale; if the one or more empty flight seats are eligible for resale, update a flight database to show the one or more empty flight seats are eligible for resale; receive a second user request from the second user device to inquire about the one or more empty flight seats for resale; provide a link to the second user device to buy the one or more empty flight seats; and hold the one or more empty seats for a time frame, wherein the time frame corresponds to a waiting time to receive a confirmation from the second user device.

Example 13: The system of claim 12, wherein when executed, the processor-executable instructions further cause the at least one processor to determine a resale cost and update the flight database, wherein the resale cost is determined based on number of empty seats and lead time.

Example 14: The system of claim 12 wherein when executed, the processor-executable instructions further cause the at least one processor to send a credit to the first user device for selling the one or more empty flight seats.

Example 15: The system of claim 12 wherein when executed, the processor-executable instructions further cause the at least one processor to send the confirmation to the flight operator if the one or more empty seats are resold.

Example 16: The system of claim 12 wherein when executed, the processor-executable instructions further cause the at least one processor to assign the one or more empty flight seats to a second user of the second user device.

Example 17: The system of claim 12 wherein when executed, the processor-executable instructions further cause the at least one processor to real-time synchronize status of the one or more empty flight seats.

1. A method of reselling one or more empty flight seats in a system including at least one processor, a first user device, and a second user device in communication with the at least one processor, the method comprising:
receiving, at the at least one processor, a first user request from the first user device, wherein
the first user request is received if one or more empty flight seats are available for resale, and
the first user request comprises a number of empty flight seats and flight details;
determining, by the at least one processor, if the one or more empty flight seats are eligible for resale;
if the one or more empty flight seats are eligible for resale, updating, by the at least one processor, a flight database to show the one or more empty flight seats are eligible for resale;
receiving, at the least one processor, a second user request from the second user device to inquire about the one or more empty flight seats for resale;
providing, by the at least one processor, a link to the second user device to buy the one or more empty flight seats; and
holding, by the at least one processor, the one or more empty seats for a time frame, wherein the time frame corresponds to a waiting time to receive a confirmation from the second user device.

2. The method of claim 1 further comprises determining a resale cost and updating the flight database, wherein the resale cost is determined based on number of empty flight seats and lead time.

3. The method of claim 1 further comprising sending, by the at least one processor, a credit to the first user device for selling the one or more empty flight seats.

4. The method of claim 1 further comprising, sending, by the at least one processor, the confirmation to the flight operator characterizing the one or more empty seats are resold.

5. The method of claim 1 further comprising assigning the one or more empty flight seats to a second user of the second user device.

6. The method of claim 1 further comprising real-time synchronizing status of the one or more empty seats.

7. The method of claim 1, wherein the one more empty flight seats are eligible for resale is based on lead time, number of remaining unsold empty seats, or passenger characteristics.

8. The method of claim 1, wherein:
the first user device is associated with a first user and the first user is a reseller of the one or more empty flight seats; and
the second user device is associated with the second user, and the second user is a buyer of the one or more empty flight seats.

9. The method of claim 1, wherein the flight details comprise a departure date, a departure location, an arrival location, flight operator information, and a seat number assigned for each of the one or more empty seats.

10. The method of claim 1, wherein the second user request comprises a declarative request for transportation on aircraft within a timeframe.

11. The method of claim 1, wherein determining if the first user request contains one or more empty flight seats eligible for resale and checking with a flight operator corresponding to the flight details.

12. A system comprising:
a first user device and a second user device, wherein the first user device and the second user device are processor-based;
at least one processor communicatively coupled to the first user device and the second user device; and
at least one non-transitory processor-readable storage device communicatively coupled to the at least one processor and which stores processor-executable instructions which, when executed by the at least one processor, cause the at least one processor to:
receive a first user request from the first user device, wherein the first user request is received if one or more empty flight seats are available for resale, and the first user request comprises a number of empty flight seats and flight details;
determine if the one or more empty flight seats are eligible for resale;
if the one or more empty flight seats are eligible for resale, update a flight database to show the one or more empty flight seats are eligible for resale;
receive a second user request from the second user device to inquire about the one or more empty flight seats for resale;
provide a link to the second user device to buy the one or more empty flight seats; and
hold the one or more empty seats for a time frame, wherein the time frame corresponds to a waiting time to receive a confirmation from the second user device.

13. The system of claim 12, wherein when executed, the processor-executable instructions further cause the at least one processor to determine a resale cost and update the flight database, wherein the resale cost is determined based on number of empty seats and lead time.

14. The system of claim 12 wherein when executed, the processor-executable instructions further cause the at least one processor to send a credit to the first user device for selling the one or more empty flight seats.

15. The system of claim 12 wherein when executed, the processor-executable instructions further cause the at least one processor to send the confirmation to the flight operator if the one or more empty seats are resold.

16. The system of claim 12 wherein when executed, the processor-executable instructions further cause the at least one processor to assign the one or more empty flight seats to a second user of the second user device.

17. The system of claim 12 wherein when executed, the processor-executable instructions further cause the at least one processor to real-time synchronize status of the one or more empty flight seats.
